(19) United States
(12) Patent Application Publication
(10) Pub. No.: US 2008/0032837 A1
(43) Pub. Date: Feb. 7, 2008

(54) Toothed belt having a tooth covering made of fabric

(76) Inventors: Axel Unruh, Hannover (DE); Michael Well, Vechelde (DE); Claus-Luder Mahnken, Ahausen (DE); Jorg Tams, Hannover (DE); Henning Kanzow, Hannover (DE); Hermann Schulte, Garbsen (DE)

Correspondence Address: WALTER OTTESEN, PO BOX 4026, GAITHERSBURG, MD, 20885-4026, US

(21) Appl. No.: 11/812,544

(22) Filed: Jun. 20, 2007

Related U.S. Application Data
(63) Continuation-in-part of application No. PCT/EP05/12312, filed on Nov. 17, 2005.

(30) Foreign Application Priority Data
Dec. 21, 2004 (DE) 10 2004 062 760.6

(51) Int. Cl. F16G 1/28

(52) U.S. Cl. 474/143; 156/138; 474/205; 474/267

(57) ABSTRACT

An HNBR-based toothed rubber belt (10) with a glass, carbon and/or aramid cord reinforcement (5) has a modified tooth covering (6) made of polyamide 6.6 fabric having weft threads (64) entirely or partly replaced in the peripheral/longitudinal direction of the belt by yarns made of polyether ether ketone (PEEK), polyimide (PI) and/or meta-aramid (M-A) or modified with PEEK, PI and/or M-A.

### CROSS REFERENCE TO RELATED APPLICATIONS

This application is a continuation-in-part of, claims under international conventions and 35 U.S.C. 119, 120 and 363 the benefit of the effective filing dates of, and hereby incorporates by reference the subject matters of, German patent application no. 10 2004 062 760.6, filed Dec. 21, 2004, and international application no. PCT/EP 2005/012312, filed Nov. 17, 2005.

### FIELD OF THE INVENTION

The invention relates to woven fabric coverings for the teeth of toothed belts and to belts having a corresponding tooth layer.

### BACKGROUND OF THE INVENTION

Toothed belts are primarily used as power transmission belts. In this use, the teeth of the toothed belt engage between the teeth of an opposite belt or of a toothed disc to effect power transmission. Toothed belts are often used in synchronous or positive drives, for example to provide synchronization between two rotating shafts.

Toothed belts used in the automotive sector are frequently standard rubber toothed belts having, in general, a rearward region, a toothed front region and an interposed tensile layer based on, for example, steel or glass cord. The toothed front region frequently includes a vulcanizate based on HNBR, that is, a hydrogenated acrylonitrile-butadiene rubber copolymer which customarily includes fillers. The mechanical and thermal resistance demands on such belts increase with increases in the power levels of the machines in which they are used. Long durability and high mechanical resistance over a broad service temperature range are therefore indispensable. Examples of toothed belts are described in WO 00/29762 and U.S. Pat. No. 4,775,357.

To enhance the mechanical stability of toothed belt teeth, the surfaces of the teeth may be provided with a covering which is generally continuous and completely covers the crests, flanks and roots of the teeth. This covering can include a coating of, for example, a modified vulcanizate, or it can preferably be formed from a knitted or woven fabric. Woven polyamide 6.6 stretch fabric has proved very useful for this purpose in that it has good mechanical properties and good adhesion to the tooth rubber.

However, nylon fabric has the disadvantage that it is thermally damaged when the toothed belts are operated for prolonged periods at high temperatures (above 110° C.). This tends to promote tooth shearing and attendant early failures of the belts.

As motor vehicles are being equipped with more and more powerful internal combustion engines, and engines are more and more completely enclosed to reduce noise, toothed belts are exposed to ever higher operating temperatures. Thus, an urgent need has arisen for woven fabric tooth coverings having superior and long-term high temperature resistance.

It has therefore been proposed, for example in WO 00/29762, to use coverings other than woven polyamide fabrics. However, the results have not been altogether satisfactory.

### SUMMARY OF THE INVENTION

It is therefore an object of the invention to avoid problems encountered with prior art fabrics and belts and to provide coverings for toothed belts which afford or increase thermal stability and inhibit failure while substantially retaining good mechanical properties.

To achieve this goal in a woven fabric covering for the toothed surface of a toothed belt, a blend fabric is provided based on polyamide wherein at least a substantial portion of the threads in the fabric comprise at least one member of the group consisting of polyether ether ketone (PEEK), polyimide (PI), meta-aramid (M-A), including combinations thereof. Belts containing such fabric tooth coverings have been found to have beneficial thermal stability properties that tend to promote enhanced power transmission belt service life, as compared to belts in which the tooth covering fabric is exclusively of polyamide.

Thus, in one aspect the invention includes a woven tooth covering fabric for covering the toothed surface of a toothed belt, characterized in that the fabric is a blend fabric in which the threads of the fabric, in the aggregate, comprise about 50% or more by weight of polyamide polymeric units and an amount up to about 50% by weight of polymeric units of at least one member selected from the group(consisting of polyether ether ketone (PEEK), polyimide (PI) and meta-aramid (M-A) polymeric units, that is sufficient to contribute enhanced thermal resistance to power transmission belts having power transmitting teeth covered by the fabric and operating above 110° C., as compared to otherwise similar belts in which such PEEK, PI and/or M-A polymeric units are replaced with polyamide polymeric units.

In another aspect, the invention includes a method of making a toothed power transmission belt comprising fixedly securing to the crests, flanks and roots of the teeth of such a belt any of the polyamide-based woven fabrics described in the present application.

In yet another aspect the invention includes a toothed power transmission belt comprising a tooth covering of any of the polyamide-based woven fabrics described in the present application. In such belts the fabric may for example comprise at least a first set of threads comprising polyamide polymeric units and at least a second set of threads that comprise at least one material selected from the group consisting of polyether ether ketone (PEEK), polyimide (PI) and meta-aramid (M-A) polymeric units, and the fabric is secured to the belt with the threads of the second set at an angle or angles to the belt running direction of less than 45 degrees, more preferably less than 25 degrees and still more preferably from zero to about 15 degrees, when viewed at the tooth crests.

For purposes of the present invention, “thread” includes any thread-like member comprising for example mono-filaments or plural filaments, which includes for instance twisted threads, yarns generally and staple filament yarns. Threads, including yarns, comprising multiple substantially continuous and/or discontinuous fibers and/or filaments, arranged compactly or with spacing or curling in lateral directions in the thread cross-section, are contemplated.

In this context, “polyamide” refers to solid polymers suitable for use in threads and having any suitable structure, for example homo- and co-polymers, including block- and graft-polymers, having in the polymer structure polymeric units of the kind found in polyamide polymers, and preferably having repeating units of such kind, for example as in nylon. Such polymeric units are present in the polymer structure in sufficient amounts, preferably about 50% or more based on polymer weight, to provide in the fabric sufficient mechanical properties for use in power transmission belts with the kinds of rubber useful in the tooth portions of power transmission belts such as HNBR.

In this context, polyether ether ketone (PEEK), polyimide (PI) and meta-aramid (M-A) refer to solid polymers suitable for use in threads and having any suitable structure, for example homo- and co-polymers, including block- and graft-polymers, having in the polymer structure polymeric units of the kind found in PEEK, PI and/or M-A polymers, and preferably having repeating units of such kind. Such polymeric units are present in sufficient amounts to provide in the fabric sufficient mechanical properties, during operation under load at and above 110° C., for use in power transmission belts.

Other polymeric species may be present in the fabric, but since the fabric is, overall, based on polyamide, polyamide units represent about 50% or more, on an aggregate weight basis, of the polymeric units present in the threads of the fabric. More preferably, such polyamide units represent at least about 75% and still more preferably at least about 85% by weight of thread weight. In the fabric as a whole, PEEK, PI and/or M-A polymeric units are present in the aforesaid sufficient amounts which may be in the range of about 1 to about 50%, preferably about 1 to about 35%, more preferably about 2.5 to about 25% and still more preferably about 2.5 to about 10%, based on the total weight of threads in the fabric.

The polyamide and member or members of the group of PEEK, PI and M-A may be present in the same and/or different threads of the fabric in the form of separate polymers and/or modified polyamide polymers. Modified polyamide structures may for example include threads in which individual fibers of a thread contain, as components of the same polymer, polyamide polymeric units and polymeric units of PEEK, PI and/or M-A. Instead of being combined into the same polymer, the polyamide and another polymer containing PEEK, PI and/or M-A polymeric units may be present in the same thread in the form of an intimate mixture, such as a physical combination of separate polymers. For example, mono- or plural-filaments containing such separate polymers in intimate admixture may be formed from molten blends of the separate polymers and such filaments may thus constitute or be formed into threads of substantially uniform composition.

Other same-thread structures include, for instance, threads formed of multiple fibers, including filaments, in which some of the individual fibers are of polyamide and other individual fibers are of one or members of the PEEK, PI and/or M-A group. Yet another example of same-thread structures includes a mixture twist, a twisted thread unit formed by twisting a pre-formed thread comprising polyamide polymeric units with another pre-formed thread comprising polymeric units of the above-mentioned group. When such mixture twist is formed by twisting pre-formed yarn of polyamide with separate pre-formed yarn of a member of the PEEK, PI and/or M-A group, it is referred to as a yarn twist.

In one embodiment of the invention believed to be particularly useful, the fabric includes a first set of threads that comprises, on a weight basis, ranging from about 50%, and preferably more than 50%, up to substantially entirely of polyamide polymeric units and a second, different set of threads that comprises PEEK, PI and/or M-A polymeric units. The threads of the second set may comprise some polyamide polymeric units or none. In a particularly preferred embodiment, the first set may for example be composed substantially or entirely of threads that consist essentially of polyamide polymer and most preferably nylon 6.6. In this preferred embodiment and in others, the second set of threads may for example be composed substantially or entirely of threads of (a) PEEK, PI and/or M-A, or (b) polyamide modified with at least one member of the PEEK, PI and/or M-A group, or (c) separate polyamide threads and separate threads comprising at least one member of the PEEK, PI and/or M-A group, or (d) individual threads comprising both (I) individual fibers, including filaments, of polyamide and (ii) individual fibers, again including filaments, of at least one member of the PEEK, PI and/or M-A group.

These thread sets can run in the same and/or different directions in the fabric weave. For instance, twisted or untwisted pairs of threads that include one thread of the first set and one thread of the second set can be set up to extend generally in at least one first direction in the weave, while similar twisted or untwisted pairs can be set up to extend generally in at least one second direction, which may be perpendicular and/or at another angle or angles to the first direction in the weave. As another example, pairs of this same kind can be used in one direction while single threads composed substantially of polyamide could be used in the other direction.

In a simple but useful embodiment, at least some of the first and second sets of threads run in different directions in the fabric weave. For instance, substantially all threads of the first set may run in at least one direction and substantially all threads of the second set may run in at least one other direction. Also, by way of example, substantially all threads of the first set may run in a single direction and substantially all threads of the second set may run in a single but different direction.

The reference to threads extending in a given direction includes the possibility that not all portions of those threads will extend in the particular direction, as in the case of the fibers of a yarn. Also, threads extending in a given direction may for instance reverse direction during the weaving process, for instance in the case of movement of a weft thread in a loom and its ultimate configuration in the resultant fabric.

Any useful weave configuration may be used, such as those used in making stretch nylon. Other suitable weaving patterns may be employed. Weave patterns which increase the amount of a particular thread represented in a given surface of the fabric are just one of many types of weaves that may be employed.

In weaving practice, the fabric may for example be woven in a loom with the first set of threads, for example those comprising or consisting essentially of polyamide threads, representing either the weft or the warp, but preferably representing the warp. Similarly, the second set of different threads comprising at least one member of the PEEK, PI and/or M-A group may represent either the weft or the warp, but preferably represent the weft.

In the manufacture of toothed belts, the threads of the fabric, as viewed at the crests or roots of the teeth, may be oriented at any desired angle, for example they may be biased, relative to the running direction, also referred to as the peripheral/longitudinal direction, of the belt. However, where the fabric comprises first and second sets of different threads, as above described, it is preferred that the angle or angles between the threads of the second set and the belt running direction is/are less than 45 degrees, more preferably less than about 25 degrees and still more preferably in the range of zero to about 15 degrees, when viewed at the tooth crests. While not wishing to be bound by any theory, it appears that belt performance improves as such angle(s) approach zero degrees and it is thus preferred that this angle be about zero degrees, so that the second set of threads runs over the belt teeth in substantially the running direction of the belt. For the sake of convenient reference, the threads of the second set which, when included in a belt are preferably oriented generally in the running direction of the belt, may be referred to as weft threads, whether or not they represented weft threads in the weaving process.

Surprisingly it was found that with certain preferred embodiments the temperature resistance and stability of a toothed belt comprising a tooth covering of a woven polyamide fabric can be improved to an astonishing degree when exclusively the weft threads, which can be present as single threads or as plied yarns, are entirely or partly replaced by threads or yarns of the above-mentioned materials or mixtures thereof or have been modified with these materials. In this context, modification does not refer to mere application of a coating or finish, since this might impair the good mechanical properties of the polyamide. Preferably, at least the warp threads, or more preferably the warp threads and at least a portion of the weft threads, continue to consist essentially of polyamide in order to confer on the covering fabric the associated positive properties to the desired degree.

The base fabric is preferably a woven polyamide 6.6 stretch fabric.

In this base fabric, preferably 2 to 70% and more preferably 5 to 50% and even more preferably 5 to 20% of the weft threads, on a number basis, are replaced by threads or yarns of polyether ether ketone, polyimide and/or meta-aramid. The specified fraction of the replaced weft threads can comprise or consist of one of these materials, or of a mixture of these materials, with or without polyamide. The polyamide weft threads can further be replaced such that a plurality of yarns or threads of the various materials mentioned can be used in lieu of polyamide weft yarns or threads.

In an alternative embodiment, some or all of the polyamide weft threads can be modified with polyether ether ketone, polyimide and/or meta-aramid to an extent which is preferably in the range from 2 to 70%, more preferably in the range from 5 to 50% and even more preferably in the range from 5 to 20% by weight. This can take the form of the weft threads as a whole consisting of a polyamide modified with PEEK, PI and/or meta-aramid in the form of polymer mixtures or copolymers. The modification of the weft threads can also take the form of individual twisted threads within a yarn being replaced by threads of PEEK, PI and/or meta-aramid, preferably in the fractions mentioned.

The replacement or modified threads are employed to best advantage when distributed throughout any remaining or unmodified threads. Preferably, such distribution, whether random or regular, is substantially uniform among the weft threads of the fabric.

To further increase wear resistance, portions of the polyamide weft threads may comprise PTFE, that is, such threads may be modified with PTFE, may be replaced by yarns or individual threads of PTFE or may have a PTFE finish.

Preferably, in one or more stages, the tooth covering can be coated on at least one-side with an adhesion promoter and/or a vulcanizate to still further enhance the bonding of the covering to the tooth surface and/or reduce wear and abrasion.

The invention further comprises a toothed belt, equipped with a tooth covering of woven fabric according to any of the claims herein.

Such a toothed belt is preferably a rubber toothed belt, most preferably one in which at least the toothed portion comprises a hydrogenated acrylonitrile-butadiene rubber copolymer. It is further preferred that the toothed belt has at least one tensile strand for reinforcement which preferably comprises filaments of glass, carbon and/or aramid in the form of cords. The tooth covering of the invention significantly increases the service life at high temperatures (above 110° C.) of the toothed belt equipped therewith and distinctly delays the failure mechanism of tooth shear.

In addition, the belt back surface can be protected with a further woven fabric.

### BRIEF DESCRIPTION OF THE DRAWING

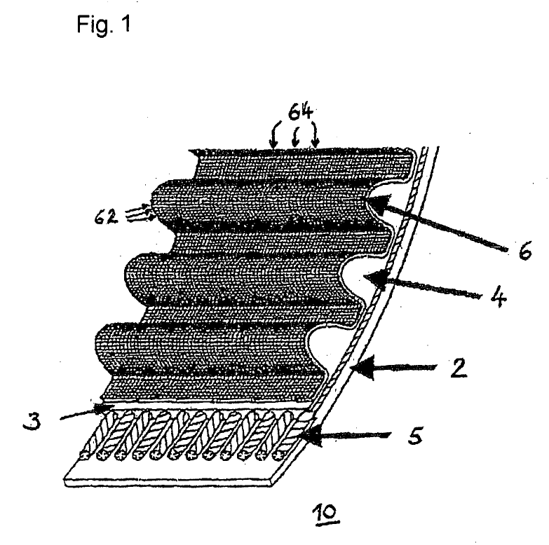

A specific embodiment of the invention will now be described in conjunction with the single figure (FIG. 1) of the drawing.

### DESCRIPTION OF THE PREFERRED EMBODIMENTS OF THE INVENTION

FIG. 1 is a schematic section through a toothed belt. This belt 10, of which only a portion is shown, has a back-side 2 and a front toothed portion 3 having individual teeth 4 for engagement with the teeth of a counter-part (not shown). A tensile layer of individual tensile strands 5, for example of glass cord, steel cord, carbon cord or aramid cord, is disposed between the back-side 2 and the front portion 3 of the belt. The toothed surface of the front portion 3 of the belt is covered with a tooth covering 6 configured in the form of a woven fabric having warp threads 62 and weft threads 64. The weft threads accordingly extend in the longitudinal direction of the belt, which is frequently configured as an endless belt, parallel to the tensile strands 5. A portion of the weft yarns of the woven polyamide 6.6 stretch fabric have in this example been replaced by PEEK yarns of the appropriate linear density, while the remaining weft threads continue to consist of polyamide 6.6, as do the warp threads 62.

### EXAMPLES

Toothed belts in which 5%, 8.5%, 10% and 20% of the polyamide weft threads are replaced by a PEEK weft yarn were measured and rated good with the use of higher fractions being easily possible depending on the intended use of the belt.

Comparison Tests

A maximum force test is carried out on a conventional toothed belt and on a toothed belt according to the invention. The test belts are 15 mm wide. An electrically braked distributor injection pump engine is used in the experiments, and its speed of rotation is constantly readjusted such that a maximum torque acts on the belts. The test is carried out in a hot box at a controlled belt temperature of 160° C. A tension of 350N is applied to the belts.

A mass produced toothed belt consisting of polyamide 6.6 fabric, a tensile strand of glass cord and an HNBR rubber mixture is compared to a belt wherein a portion of the weft threads in the tooth covering are replaced by PEEK yarns.

Results

| | A | B |
|---|---|---|
| Belt type: | Mass produced | Toothed belt of the |
| | toothed belt | invention |
| Tooth material: | HNBR rubber mixture | HNBR rubber mixture |
| Tensile strand | glass cord | as for A |
| | | Glass cord as for A |
| Tooth covering: | Polyamide 6.6 | Base fabric: |
| | fabric | Polyamide 6.6 fabric |
| | | as for A with 10% of |
| | | weft threads replaced |
| | | by PEEK yarns of |
| | | corresponding linear |
| | | density |
| Average time to | 48 h | 95 h |
| failure | | |

It is understood that the foregoing description is that of the preferred embodiments of the invention and that various changes and modifications may be made thereto without departing from the spirit and scope of the invention as defined in the appended claims.

What is claimed is:

1. A woven tooth covering fabric for covering the toothed surface of a toothed belt, characterized in that the fabric is a blend fabric in which the threads of the fabric, in the aggregate, comprise about 50% or more by weight of polyamide polymeric units and an amount up to about 50% by weight of polymeric units of at least one member selected from the group consisting of polyether ether ketone (PEEK), polyimide (PI) and meta-aramid (M-A) polymeric units, that is sufficient to contribute enhanced thermal resistance to power transmission belts having power transmitting teeth covered by the fabric and operating above 110° C., as compared to otherwise similar belts in which such PEEK, PI and/or M-A polymeric units are replaced with polyamide polymeric units.

2. A woven tooth covering according to claim 1 in which individual threads of the fabric comprise polyamide polymeric units in a co-polymer with polymeric units of said group.

3. A woven tooth covering according to claim 1 in which individual threads of the fabric comprise a first polymer comprising polyamide polymeric units and, in the same threads, a second polymer, different from but mixed with the first, comprising polymeric units of said group.

4. A woven tooth covering according to claim 3 in which the polymeric units of said group represent up to 70% by weight of the second polymer.

5. A woven tooth covering according to claim 1 in which individual threads of the fabric comprise fibers comprising polyamide polymeric units and, in the same threads, other fibers comprising polymeric units of said group.

6. A woven tooth covering according to claim 5 in which the other fibers comprise up to 70% by weight of the fibers of these individual threads.

7. A woven tooth covering according to claim 5 in which the other fibers are composed substantially of polymeric units of said group.

8. A woven tooth covering according to claim 1 in which individual threads of the fabric comprise pre-formed yarns or other threads including the polyamide polymeric units, which yarns or other threads are twisted into a unitary thread structure with other pre-formed yarns or other threads that include the polymeric units of said group.

9. A woven tooth covering according to claim 8 in which the pre-formed yarns or other threads that include the polymeric units of said group represent up to 70% by weight of the fibers of these individual threads.

10. A woven tooth covering according to claim 8 in which the pre-formed yarns or other threads that include the polymeric units of said group are composed substantially of polymeric units of said group.

11. A woven tooth covering according to claim 1 wherein the fabric comprises threads composed substantially of polyamide polymeric units and separate threads comprising polymeric units of said group.

12. A woven tooth covering according to claim 11 in which the the polymeric units of said group represent up to 70% by weight of the separate threads.

13. A woven tooth covering according to claim 11 in which the separate threads are composed substantially of polymeric units of said group.

14. A tooth covering fabric according to any preceding claim in which the fabric is a woven stretch fabric based on polyamide 6.6.

15. A tooth covering fabric according to any preceding claim in which at least a portion of the threads of the woven fabric comprise filaments, yarns or twisted threads.

16. A tooth covering fabric according to claim 1 in which the threads comprise first threads, comprising about 50% or more by weight of polyamide polymeric units, and second threads, of different polymer composition from the first, comprising at least one member from said group.

17. A tooth covering fabric according to claim 16 in which the second threads comprise PEEK.

18. A tooth covering fabric according to claim 16 in which the second threads comprise PI.

19. A tooth covering fabric according to claim 16 in which the second threads comprise M-A.

20. A tooth covering fabric according to claim 16 in which the first threads comprise more than 50% by weight of polyamide polymeric units.

21. A tooth covering fabric according to claim 16 in which the first threads comprise at least about 75% by weight of polyamide polymeric units.

22. A tooth covering fabric according to claim 16 in which the first threads comprise at least about 85% by weight of polyamide polymeric units.

23. A tooth covering fabric according to claim 16 in which the first threads are composed substantially entirely of polyamide polymeric units.

24. A tooth covering fabric according to claim 16 in which the number of second threads comprising PEEK, PI and/or M-A represents 2 to 70%, preferably 5 to 50% and more preferably 5 to 20% of the total number of second threads.

25. A tooth covering fabric according to claim 16 in which the second threads are composed substantially of PEEK, PI and/or M-A polymeric units.

26. A tooth covering fabric according to claim 16 in which individual second threads comprise copolymer comprising polyamide polymeric units and polymeric units of PEEK, PI and/or M-A in which such PEEK, PI and/or M-A polymeric units represent 2 to 70%, preferably 5 to 50% and more preferably 5 to 20% by weight of the total weight of co-polymer.

27. A tooth covering fabric according to claim 16 in which individual second threads comprise a first polymer comprising polyamide polymeric units and, in the same threads, a second polymer, mixed with the first, comprising polymeric units of said group, in which such PEEK, PI and/or M-A polymeric units represent 2 to 70%, preferably 5 to 50% and more preferably 5 to 20% by weight of the total weight of these individual threads.

28. A tooth covering fabric according to claim 16 in which individual second threads comprise fibers of a first polymer comprising polyamide polymeric units and, in the same threads, fibers of a second polymer, mixed with the first fibers, that comprise polymeric units of said group, in which such PEEK, PI and/or M-A polymeric units represent 2 to 70%, preferably 5 to 50% and more preferably 5 to 20% by weight of the total weight of the fibers present in these individual threads.

29. A tooth covering fabric according to claim 16 in which the first threads comprise polyamide homo-polymer and the second threads comprise copolymer comprising polyamide polymeric units and units of PEEK, PI and/or M-A in which such PEEK, PI and/or M-A polymeric units represent 2 to 70%, preferably 5 to 50% and more preferably 5 to 20% by weight of the total weight of co-polymer.

30. A tooth covering fabric according to claim 29 in which the first threads are composed substantially of the polyamide homo-polymer and the second threads are composed substantially of the copolymer comprising polyamide polymeric units and units of PEEK, PI and/or M-A.

31. A tooth covering fabric according to claim 16 in which the first and second threads, in the aggregate, comprise at least about 65% by weight of polyamide polymeric units and up to about 35%, preferably up to about 25% and more preferably up to about 10% by weight of polymeric units of PEEK, PI and/or M-A.

32. A tooth covering fabric according to any preceding claim in which the threads comprise fibers that are continuous and/or discontinuous, are twisted and/or untwisted and are present in the threads in the form of mono- or plural-filaments, yarns and/or pre-formed threads.

33. A tooth covering fabric according to any preceding claim in which the threads comprise PTFE.

34. A tooth covering fabric according to any preceding claim in which the blend fabric is coated on at least one side with adhesion promoter and/or elastomer.

35. A method of making a toothed power transmission belt comprising bonding to the crests, flanks and roots of the teeth of such a belt a polyamide-based woven fabric according to any preceding claim.

36. A method according to claim 35, comprising using as the fabric a fabric having a first set of threads comprising polyamide polymeric units, providing in said fabric a second set of threads that comprise at least one polymeric material comprising polymeric units selected from the group consisting of polyether ether ketone (PEEK), polyimide (PI) and meta-aramid (M-A), and bonding the fabric to the teeth of the belt with the threads of the second set at an angle or angles to the belt running direction of less than 45 degrees, more preferably less than 25 degrees and still more preferably from zero to about 15 degrees, when viewed at the tooth crests.

37. A method according to claim 35 comprising aligning the threads of the second set substantially with the running direction of the belt.

38. A method according to claim 35 comprising providing fabric in which the threads of the second set represent weft threads of the fabric, and orienting these weft threads at said angle or angles to the running direction of the belt.

39. A method according to claim 38 comprising aligning the weft threads substantially with the running direction of the belt.

40. A toothed power transmission belt comprising a tooth covering according to any preceding polyamide-based woven fabric claim.

41. A toothed power transmission according to claim 40 in which the fabric comprises at least a first set of threads comprising polyamide polymeric units and at least a second set of threads that comprise at least one material selected from the group consisting of polyether ether ketone (PEEK), polyimide (PI) and meta-aramid (M-A) polymeric units, and the fabric is secured to the belt with the threads of the second set at an angle or angles to the belt running direction of less than 45 degrees, more preferably less than 25 degrees and still more preferably from zero to about 15 degrees, when viewed at the tooth crests.

42. A toothed belt according to claim 40 in which at least the toothed portion of the belt comprises hydrogenated acrylonitrile-butadiene rubber copolymer.

43. A toothed belt according to claim 40 which comprises at least one tensile strand for reinforcement, preferably comprising filaments of glass, steel, carbon and/or aramid.
